(19) United States
(12) Patent Application Publication
(10) Pub. No.: US 2023/0281331 A1
(43) Pub. Date: Sep. 7, 2023

(54) CONTROL METHOD AND INFORMATION PROCESSING APPARATUS

(71) Applicant: Fujitsu Limited, Kawasaki-shi (JP)

(72) Inventors: Chunpeng Ma, Kawasaki (JP); Tomoya Iwakura, Kawasaki (JP); Yuzi Kanazawa, Setagaya (JP); Tetsuro Takahashi, Yokohama (JP)

(73) Assignee: Fujitsu Limited, Kawasaki-shi (JP)

(21) Appl. No.: 18/082,154

(22) Filed: Dec. 15, 2022

(30) Foreign Application Priority Data
Mar. 3, 2022 (JP) 2022-032320

(51) Int. Cl. G06F 21/62

(52) U.S. Cl. CPC G06F 21/6218

(57) ABSTRACT

A non-transitory computer-readable recording medium stores a program for causing a computer to execute a process, the process includes extracting a plurality of candidates for an entity in a knowledge graph based on a word in text, collecting related images related to the extracted candidates, generating image clusters of the collected related images for the respective candidates, calculating degrees of similarity between the generated image clusters, and determining, as the entity, a candidate of which the image cluster indicates a higher degree of similarity among the candidates.

### CROSS-REFERENCE TO RELATED APPLICATION

This application is based upon and claims the benefit of priority of the prior Japanese Patent Application No. 2022-32320, filed on Mar. 3, 2022, the entire contents of which are incorporated herein by reference.

### FIELD

The embodiment discussed herein is related to a control method and an information processing apparatus.

### BACKGROUND

A technique called entity linking for associating a word in text with an entity in a knowledge graph that is a knowledge base is known. Multimodal entity linking for associating not only a word but also image information included in Instagram (registered trademark), Twitter (registered trademark), movie review sites, and the like with an entity is also known.

A technique for efficiently correcting an error of association between person images in determining whether or not persons imaged by respective cameras are the same person is known. A technique for visualizing a machine learning model for predicting an interaction between an autonomous car and a traffic entity representing a target object in traffic, such as a pedestrian, a bicycle, a vehicle, or a delivery robot is also known.

Japanese Laid-open Patent Publication No. 2017-021753 and U.S. Patent Application Publication No. 2021/0110203 are disclosed as related art.

Seungwhan Moon et al., “Zeroshot Multimodal Named Entity Disambiguation for Noisy Social Media Posts”, Proceedings of the 56th Annual Meeting of the Association for Computational Linguistics (Long Papers), pp. 2000-2008, 2018; Omar Adjali et al, “Building a Multimodal Entity Linking Dataset From Tweets”, Proceedings of the 12th Conference on Language Resources and Evaluation (LREC 2020), pp. 4285-4292, 2020; and Jingru Gan et al, “Multimodal Entity Linking: A New Dataset and A Baseline”, MM'21: Proceedings of the 29th ACM International Conference on Multimedia, pp. 993-1001, 2021 are also disclosed as related art.

### SUMMARY

According to an aspect of the embodiment, a non-transitory computer-readable recording medium stores a program for causing a computer to execute a process, the process includes extracting a plurality of candidates for an entity in a knowledge graph based on a word in text, collecting related images related to the extracted candidates, generating image clusters of the collected related images for the respective candidates, calculating degrees of similarity between the generated image clusters, and determining, as the entity, a candidate of which the image cluster indicates a higher degree of similarity among the candidates.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of entity linking (EL);

FIG. 2 is a block diagram illustrating an example of a hardware configuration of an EL control apparatus;

FIG. 3 is a block diagram illustrating an example of a functional configuration of the EL control apparatus;

FIG. 4 is a diagram illustrating an example of an image database (DB);

FIG. 5 is a flowchart illustrating an example of a process performed by the EL control apparatus;

FIG. 6A is a diagram illustrating an example of input text, FIG. 6B is a diagram illustrating an example of input of input text to an EL model and an example of output from the EL model, and FIG. 6C is a diagram illustrating an example of association of a word in input text with entity candidates;

FIG. 7 is a diagram illustrating an example of collection of related images, recursive collection of sub-related images, and generation of an image cluster;

FIGS. 8A and 8B are diagrams illustrating an example of an image cluster related to an entity candidate;

FIGS. 9A and 9B are diagrams illustrating another example of an image cluster related to an entity candidate;

FIG. 10A is a diagram illustrating an example of image clusters for which a degree of similarity is calculated, and FIG. 10B is a diagram illustrating an example of inter-image scores;

FIG. 11A is a diagram illustrating an example of a degree of similarity between image clusters, and FIG. 11B is a diagram illustrating an example of identifying the largest degree of similarity;

FIG. 12A is a diagram illustrating an example of a relationship between an entity candidate and a degree of similarity between image clusters, and FIG. 12B is a diagram illustrating an example of determining a final score and an entity; and

FIG. 13 is a diagram illustrating an example of final association between a word in input text and an entity.

### DESCRIPTION OF EMBODIMENT

The accuracy of entity linking described above is not necessarily high, and an incorrect entity is sometimes associated with a word depending on an entity linking model. Thus, there is room for improvement in the accuracy of entity linking.

In a case of improving the accuracy of entity linking, it is expected that text information that is more abstract than a word but has a relatively large number of search hits and image information that has a relatively small number of search hits relative to a word but is more specific than text information are used together. For example, in the multimodal entity linking described above, image information limited to a specific field such as Instagram (registered trademark) or movie review sites is input to a neural network. However, since a neural network specialized for a specific field is designed, there is another problem that entity linking has no versatility.

An embodiment of the present disclosure will be described below with reference to the drawings.

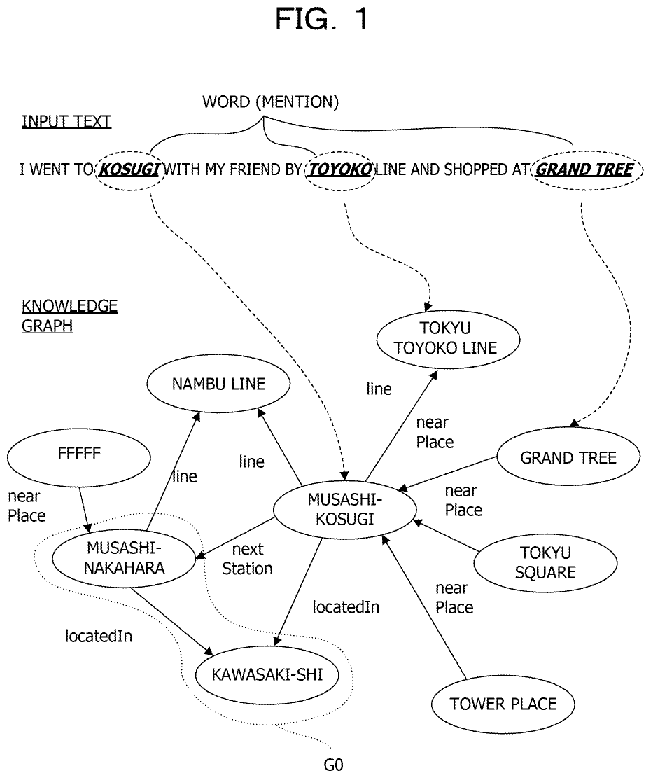

First, a concept of entity linking using a knowledge base will be described with reference to FIG. 1. FIG. 1 illustrates input text and a knowledge base. The knowledge base is represented by a knowledge graph. The knowledge graph refers to a graph that has each entity as a node and a score between entities as a weight of an edge. For example, in entity linking, a word called a mention in the input text is associated (linked) with an entity (node) of the knowledge graph, which is a knowledge base, by using a weight of an edge.

In the knowledge base, one piece of information is expressed by a triplet of a subject, a predicate, and an object. For example, as indicated by a symbol G0, one piece of information is represented by “Musashi-nakahara” serving as the subject, “locatedIn” serving as the predicate, and “Kawasaki-shi” serving as the object. Individual pieces of information are visualized as a graph. The subject and the object are represented by nodes, and the predicate is represented by an edge.

In entity linking, in a case where the input text is, for example, “I went to Kosugi with my friend by Toyoko Line and shopped at Grand Tree (registered trademark))”, “Toyoko Line” in the input text and a node “Tokyu Toyoko Line” in the knowledge base are associated with each other by using a score. “Kosugi” in the input text and a node “Musashi-kosugi” in the knowledge base are associated with each other by using a score. “Grand Tree” in the input text and a node “Grand Tree” in the knowledge base are associated with each other by using a score.

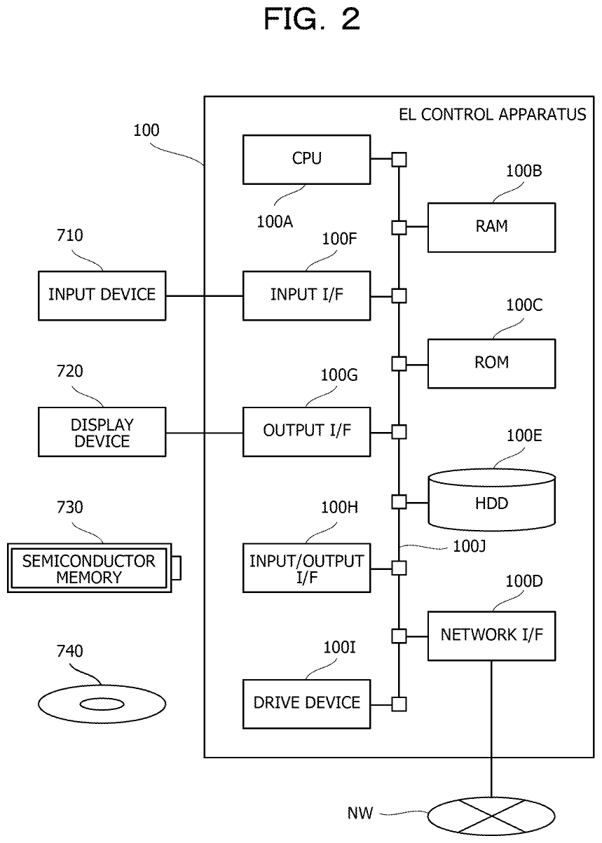

A hardware configuration of an entity linking (EL) control apparatus 100 that executes a control method for entity linking will be described below with reference to FIG. 2.

The EL control apparatus 100 includes a central processing unit (CPU) 100A as a processor, and a random-access memory (RAM) 100B and a read-only memory (ROM) 100C as memories. The EL control apparatus 100 includes a network interface (I/F) 100D and a hard disk drive (HDD) 100E. A solid-state drive (SSD) may be adopted instead of the HDD 100E.

The EL control apparatus 100 may include at least one of an input I/F 100F, an output I/F 100G, an input/output I/F 100H, or a drive device 1001 as appropriate. The CPU 100A, the RAM 100B, the ROM 100C, the network I/F 100D, the HDD 100E, the input I/F 100F, the output I/F 100G, the input/output I/F 100H, and the drive device 1001 are coupled to one another via an internal bus 100J. For example, the EL control apparatus 100 may be implemented by a computer (information processing apparatus). The computer may be a personal computer (PC), a smartphone, a tablet terminal, or the like.

An input device 710 is coupled to the input I/F 100F. Examples of the input device 710 include a keyboard, a mouse, a touch panel, and the like. A display device 720 is coupled to the output I/F 100G. Examples of the display device 720 include a liquid crystal display and the like. A semiconductor memory 730 is coupled to the input/output I/F 100H. Examples of the semiconductor memory 730 include a Universal Serial Bus (USB) memory, a flash memory, and the like. The input/output I/F 100H reads an entity linking control program stored in the semiconductor memory 730. The input I/F 100F and the input/output I/F 100H include, for example, a USB port. The output I/F 100G includes, for example, a display port.

A portable-type recording medium 740 is inserted into the drive device 100I. Examples of the portable-type recording medium 740 include a removable disc such as a compact disc (CD)-ROM or a Digital Versatile Disc (DVD). The drive device 100I reads the entity linking control program recorded on the portable-type recording medium 740. The network I/F 100D includes, for example, a local area network (LAN) port, a communication circuit, and the like. The communication circuit includes one or both of a wired communication circuit and a wireless communication circuit. The network I/F 100D is coupled to a communication network NW. The communication network NW includes one or both of a LAN and the Internet.

The entity linking control program stored in at least one of the ROM 100C, the HDD 100E, or the semiconductor memory 730 is temporarily stored in the RAM 100B by the CPU 100A. The entity linking control program recorded on the portable-type recording medium 740 is temporarily stored in the RAM 100B by the CPU 100A. The CPU 100A executes the stored entity linking control program, so that the CPU 100A implements various functions (described later) and performs various processes (described later). The entity linking control program may be a program according to a flowchart (described later).

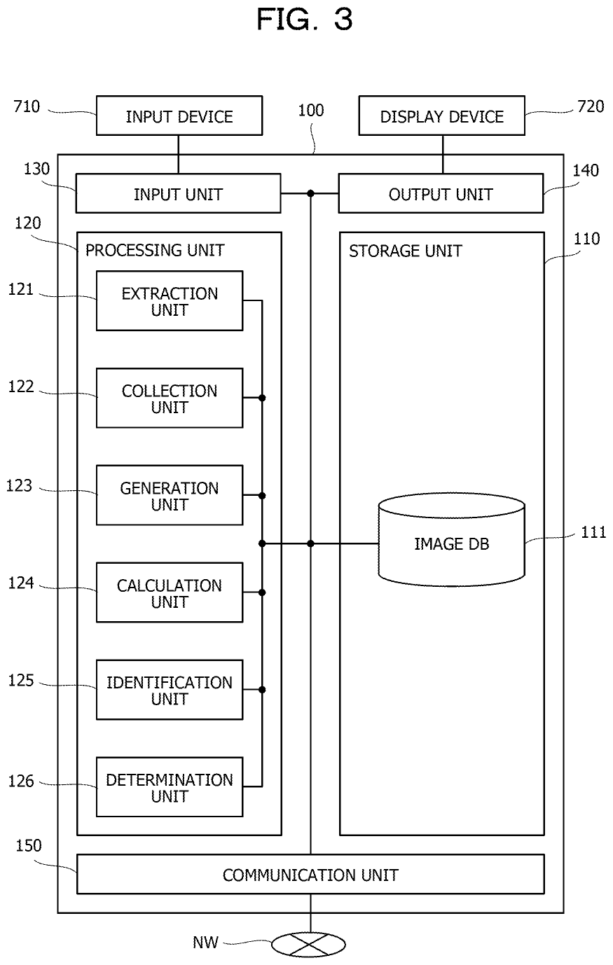

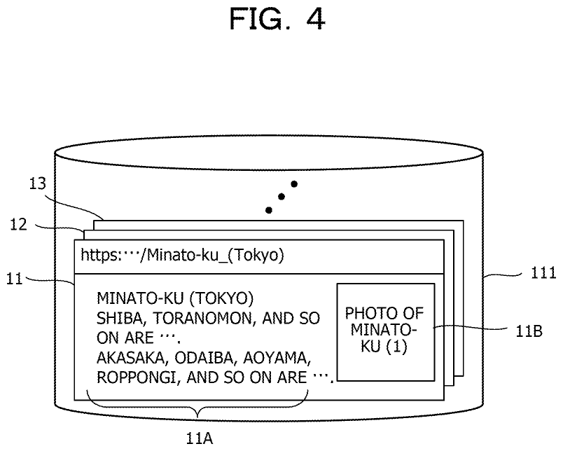

A functional configuration of the EL control apparatus 100 will be described with reference to FIGS. 3 and 4. FIG. 3 illustrates major units of functions of the EL control apparatus 100. Details of the functions of the EL control apparatus 100 will be described as appropriate when an operation of the EL control apparatus 100 is described.

The EL control apparatus 100 includes a storage unit 110, a processing unit 120, an input unit 130, an output unit 140, and a communication unit 150. The storage unit 110 may be implemented by one or both of the RAM 100B and the HDD 100E described above. The processing unit 120 may be implemented by the CPU 100A described above. The input unit 130 may be implemented by the input I/F 100F. The output unit 140 may be implemented by the output I/F 100G. The communication unit 150 may be implemented by the network I/F 100D described above.

The storage unit 110, the processing unit 120, the input unit 130, the output unit 140, and the communication unit 150 are coupled to one another. The storage unit 110 includes an image database (DB) 111. The processing unit 120 includes an extraction unit 121, a collection unit 122, and a generation unit 123. The processing unit 120 also includes a calculation unit 124, an identification unit 125, and a determination unit 126.

When the extraction unit 121 receives, via the input unit 130, text input from the input device 710, the extraction unit 121 searches the communication network NW based on a word included in the text, and extracts a plurality of entity candidates representing candidates for an entity. For example, the extraction unit 121 includes an EL model that generates a list of entity candidates. The EL model extracts a word corresponding to a named entity, and gives a score according to an accuracy of entity linking to an entity candidate. Examples of such an EL model include a classification head, a classifier, entity-context scores, and so on. A named entity is a generic term for a name such as a person's name, a place name, or an organization name, a time-related expression such as a time expression or a day-of-week expression, a numerical expression such as an amount-of-money expression or an age, and the like.

After extracting the entity candidates, the extraction unit 121 stores the entity candidates in the image DB 111. Thus, as illustrated in FIG. 4, the image DB 111 stores a plurality of entity candidates 11, 12, 13, . . . . The entity candidate 11 includes related text 11A related to an entity and a related image 11B related to the entity. For example, the related text 11A is explanatory text describing details of the entity, and the related image 11B is a representative still image of the entity. The related text 11A includes related words related to the related image 11B. For example, the related text 11A includes a related word “Shiba”, a related word “Roppongi”, and so on related to the related image 11B. Since the entity candidates 12, 13, are basically the same as the entity candidate 11, detailed description thereof will be omitted.

The collection unit 122 collects, for each of the entity candidates, a related image included in the entity candidate from the image DB 111. After collecting the related image, the collection unit 122 recursively collects related images related to the related image, based on the related words related to the collected related image. By recursively collecting the related images, the collection unit 122 may collect, for each of the entity candidates, various related images related to the entity candidate.

The generation unit 123 generates, for each of the entity candidates, an image cluster of the related images collected by the collection unit 122. Since the generation unit 123 generates, for each of the entity candidates, an image cluster of the related images, the generation unit 123 generates a plurality of image clusters. Based on a predetermined calculation method for calculating a degree of similarity between image clusters, the calculation unit 124 calculates degrees of similarity between the image clusters generated by the generation unit 123. Details of the predetermined calculation method for calculating a degree of similarity will be described later.

Among the degrees of similarity calculated by the calculation unit 124, the identification unit 125 identifies a specific degree of similarity larger than any other degrees of similarity. That is, the identification unit 125 identifies the largest degree of similarity among the degrees of similarity calculated by the calculation unit 124. Based on the specific degree of similarity identified by the identification unit 125, the determination unit 126 determines an entity corresponding to the specific degree of similarity from among the entity candidates. That is, the determination unit 126 determines, as a final entity, a candidate of which the image cluster indicates a higher degree of similarity. With these configurations, a word and an entity may be uniquely associated with each other with a high accuracy.

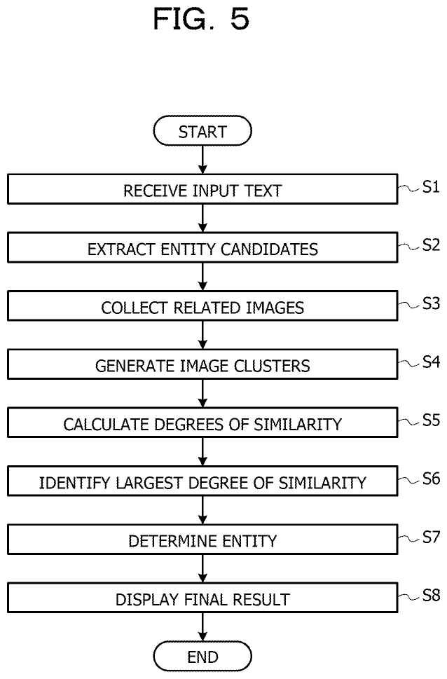

Subsequently, a process performed by the EL control apparatus 100 will be described with reference to FIGS. 5 to 13.

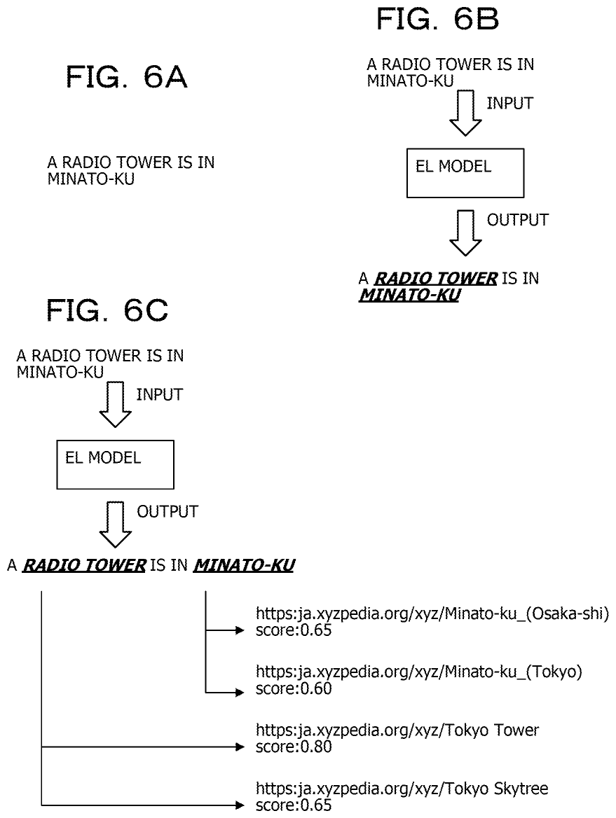

First, as illustrated in FIG. 5, the extraction unit 121 receives input text (step S1). For example, as illustrated in FIG. 6A, when input text “A radio tower is in Minato-ku” is input to the EL control apparatus 100 from the input device 710, the extraction unit 121 receives this input text.

After receiving the input text, the extraction unit 121 extracts entity candidates (step S2). For example, as illustrated in FIG. 6B, after receiving the input text, the extraction unit 121 identifies a word corresponding to a named entity from the input text since the extraction unit 121 includes an EL model. In the present embodiment, as an example, the extraction unit 121 identifies a word “radio tower” and a word “Minato-ku” corresponding to named entities. As illustrated in FIG. 6C, after identifying the words, the extraction unit 121 extracts a plurality of entity candidates based on these words.

For example, based on the word “Minato-ku”, the extraction unit 121 extracts an entity candidate “https:ja.xyzpedia.org/xyz/Minato-ku_(Osaka-shi)” and an entity candidate “https:jaiwzpedia.org/xyz/Minato-ku_(Tokyo)”. Likewise, based on the word “radio tower”, the extraction unit 121 extracts an entity candidate “https:jaiwzpedia.org/xyz/Tokyo Tower (registered trademark)” and an entity candidate “https:ja.xyzpedia.org/xyz/Tokyo Skytree (registered trademark)”. Although not illustrated, as described above, each entity candidate includes related text related to an entity and a related image related to the entity.

Each of the entity candidates is given a score according to the accuracy of entity linking. For example, in a case of the word “Minato-ku”, it is indicated that the accuracy for the entity candidate “https:ja.xyzpedia.org/xyz/Minato-ku_(Osaka-shi)” is higher than that for the entity candidate “https:ja.xyzpedia.org/xyz/Minato-ku_(Tokyo)”. In a case of the word “radio tower”, it is indicated that the accuracy for the entity candidate “https:ja.xyzpedia.org/xyz/Tokyo Tower” is higher than that for the entity candidate “https:jaiwzpedia.org/xyz/Tokyo Skytree”.

However, in light of the input text “A radio tower is in Minato-ku”, there is no radio tower in Minato-ku, Osaka-shi. Thus, it is not appropriate to associate the entity candidate “https:ja.xyzpedia.org/xyz/Minato-ku_(Osaka-shi)” and the entity candidate “https:ja.xyzpedia.org/xyz/Tokyo Tower” with this input text. For example, in light of the input text “A radio tower is in Minato-ku”, the Tokyo Skytree is in Sumida-ku, Tokyo, and is not in Minato-ku, Tokyo. In the case of the present embodiment, it is appropriate to associate the entity candidate “https:jaiwzpedia.org/xyz/Minato-ku_(Tokyo)” and the entity candidate “https:ja.xyzpedia.org/xyz/Tokyo Tower” with this input text.

Thus, after extracting the entity candidates, the extraction unit 121 stores the extracted entity candidates in the image DB 111. The collection unit 122 and the like perform subsequent processing for increasing the accuracy of entity linking.

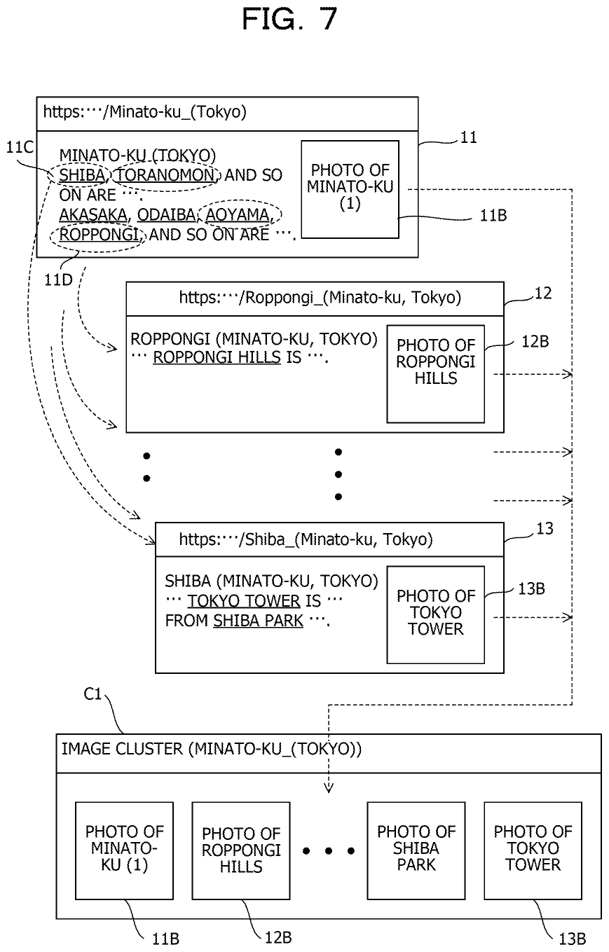

For example, after the extraction unit 121 stores the entity candidates in the image DB 111, the collection unit 122 collects related images (step S3). For example, based on the entity candidates extracted by the extraction unit 121, the collection unit 122 collects, for each of the entity candidates, a related image related to the entity candidate from the image DB 111. For example, as illustrated in FIG. 7, if the extraction unit 121 extracts the entity candidate 11, the collection unit 122 collects the related image 11B included in the entity candidate 11.

After the collection unit 122 collects the related image, the extraction unit 121 extracts a plurality of entity candidates based on related words related to the related image collected by the collection unit 122, and stores the plurality of entity candidates in the image DB 111. After the extraction unit 121 stores the plurality of entity candidates in the image DB 111, the collection unit 122 further collects images from the plurality of entity candidates in the image DB 111. For example, based on the related words related to the collected related image, the collection unit 122 recursively collects, as additional related images, sub-related images secondarily related to the related image.

For example, as illustrated in FIG. 7, after the collection unit 122 collects the related image 11B, the extraction unit 121 identifies a related word 11C (for example, “Shiba”), a related word 11D (for example, “Roppongi”), and so on related to this related image 11B. Based on the identified related words 11C and 11D, the extraction unit 121 extracts the plurality of entity candidates 12, 13, and so on corresponding to the related words 11C and 11D, and stores the plurality of entity candidates 12, 13, and so on in the image DB 111. After the extraction unit 121 stores the plurality of entity candidates 12 and 13, the collection unit 122 collects sub-related images 12B and 13B as additional related images from the plurality of entity candidates 12 and 13 in the image DB 111. As described above, the collection unit 122 collects the primary related image 11B, and recursively collects the sub-related images 12B, 13B, and the like as additional secondary related images.

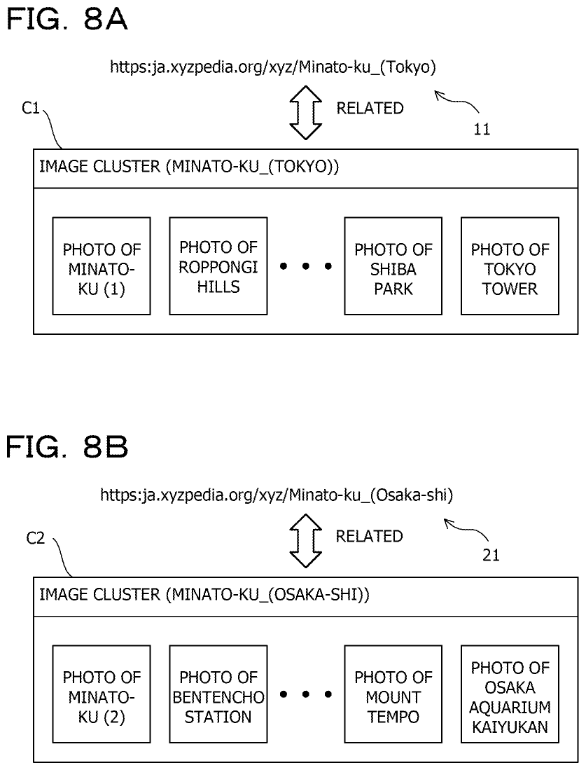

After the collection unit 122 collects the related images, the generation unit 123 generates image clusters (step S4). For example, the generation unit 123 generates an image cluster, for each of the entity candidates, of the related images collected by the collection unit 122. For example, as illustrated in FIG. 7, in a case of the entity candidate 11, the generation unit 123 generates an image cluster C1 including, as related images, the related image 11B and the sub-related images 12B, 13B, and so on related to the entity candidate 11. Thus, as illustrated in FIG. 8A, in a case of the entity candidate 11, the entity candidate 11 and the image cluster C1 may be associated with each other.

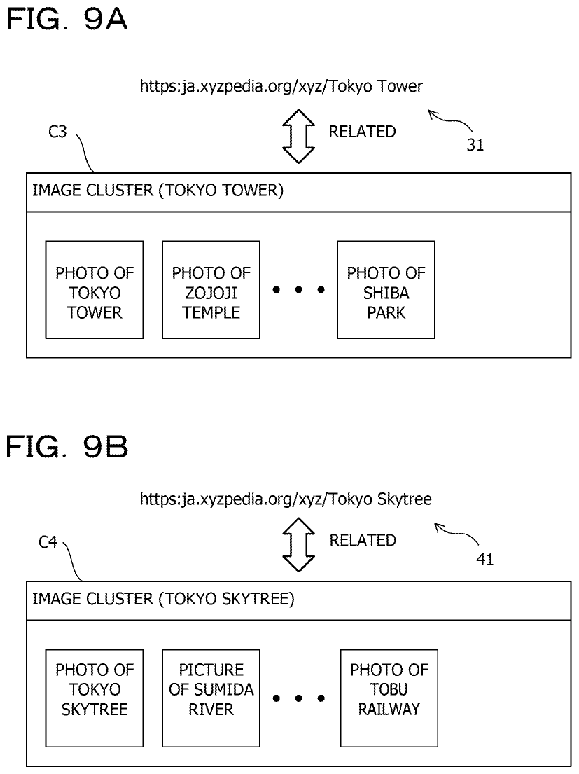

Likewise, as illustrated in FIG. 8B, in a case of an entity candidate 21, the entity candidate 21 and an image cluster C2 may be associated with each other. As illustrated in FIG. 9A, in a case of an entity candidate 31, the entity candidate 31 and an image cluster C3 may be associated with each other. As illustrated in FIG. 9B, in a case of an entity candidate 41, the entity candidate 41 and an image cluster C4 may be associated with each other.

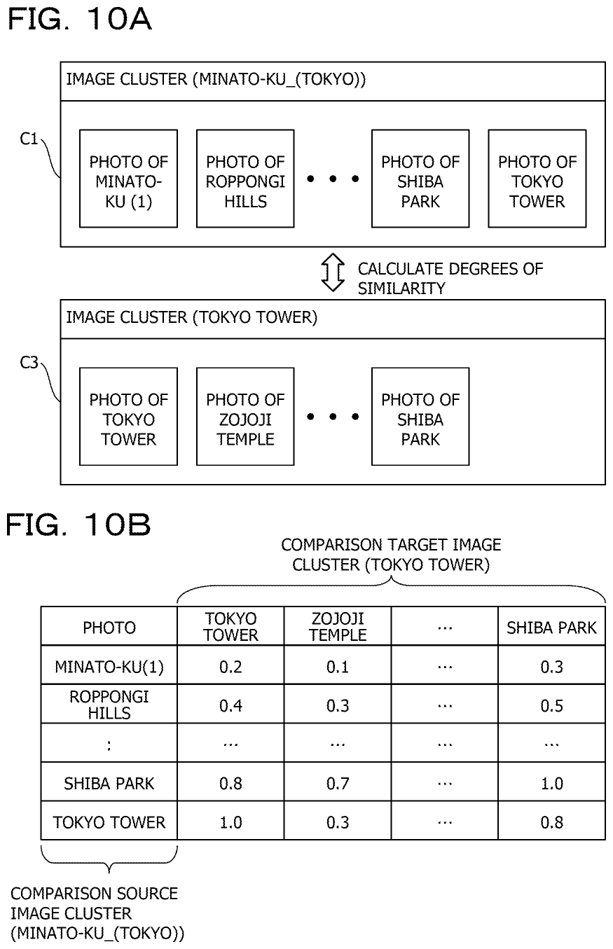

After the generation unit 123 generates the image clusters, the calculation unit 124 calculates degrees of similarity between the image clusters generated by the generation unit 123 (step S5). For example, in a case where a degree of similarity between the image clusters C1 and C3 is calculated as illustrated in FIG. 10A, the calculation unit 124 first designates the image cluster C1 as a comparison source image cluster and designates the image cluster C3 as a comparison target image cluster as illustrated in FIG. 10B.

Next, the calculation unit 124 compares each related image included in the comparison source image cluster and each related image included in the comparison target image cluster on a related-image-by-related-image basis to calculate an inter-image score. For example, in a case where the inter-image score between a related image “photo of Minato-ku (1)” included in the comparison source image cluster and a related image “photo of Tokyo Tower” included in the comparison target image cluster is calculated, the calculation unit 124 calculates an inter-image score “0.2” based on these related images and a predetermined degree-of-similarity calculation method. The calculation unit 124 calculates inter-image scores for the rest of the related images in the similar manner. Examples of this predetermined degree-of-similarity calculation method include a method in which a distributed representation of an image is calculated with a faster region-based convolutional neural network (faster R-CNN) to calculate a degree of cosine similarity of the distributed representation between images and the like.

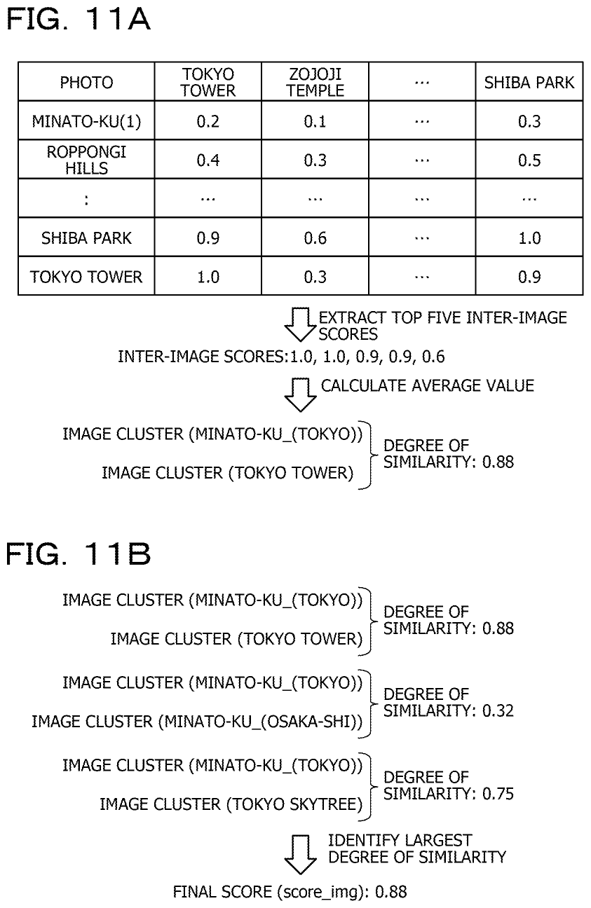

After calculating the inter-image scores, the calculation unit 124 extracts top several inter-image scores from among all the inter-image scores, and calculates an average value of the extracted inter-image scores, as illustrated in FIG. 11A. The number of inter-image scores to be extracted may be a dozen or so, several tens, several hundreds, or the like. In the present embodiment, the calculation unit 124 extracts the top five inter-image scores “1.0, 1.0, 0.9, 0.9, 0.6”, and calculates an average value “0.88” of the extracted inter-image scores. After calculating the average value of the extracted inter-image scores, the calculation unit 124 determines the calculated average value as the degree of similarity between the image clusters. By using such a method, the calculation unit 124 calculates the degree of similarity “0.88” between the image clusters C1 and C3.

As described above, after calculating the degree of similarity “0.88” between the image clusters C1 and C3, the calculation unit 124 calculates a degree of similarity “0.32” between the image clusters C1 and C2 by using the similar method, with the image cluster C1 serving a reference as illustrated in FIG. 11B. The calculation unit 124 calculates a degree of similarity “0.75” between the image clusters C1 and C4.

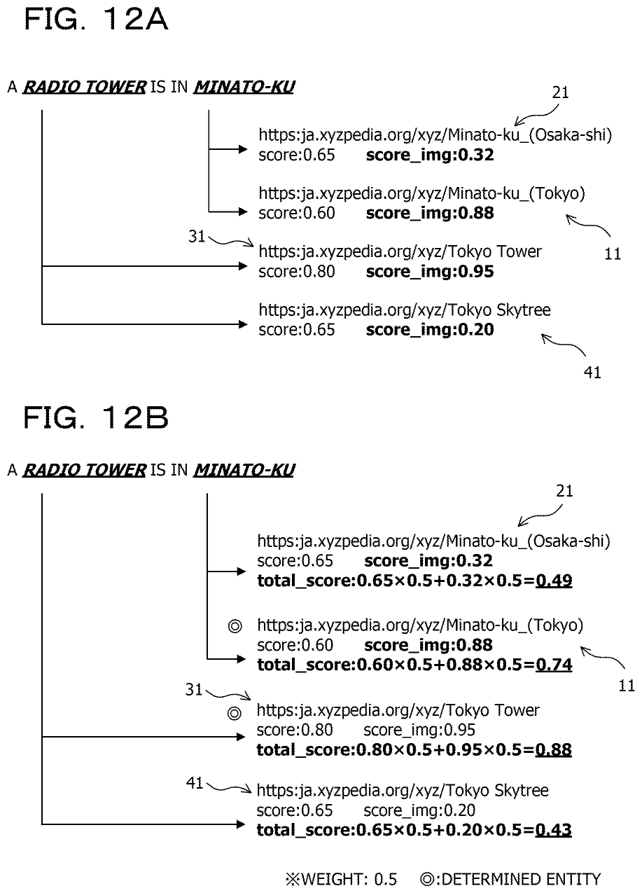

After the calculation unit 124 calculates the degrees of similarity between any one of the image clusters, which serves as the reference, and all of the rest of the image clusters, the identification unit 125 identifies the largest degree of similarity among the plurality of degrees of similarities (step S6). In a case of the present embodiment, as illustrated in FIG. 11B, the identification unit 125 identifies the largest degree of similarity “0.88”. After identifying the largest degree of similarity, the identification unit 125 determines the identified largest degree of similarity as a final score (score_img) of the entity candidate related to that image cluster. In a case of the present embodiment, the identification unit 125 determines the largest degree of similarity “0.88” as the final score of the entity candidate 11 related to the image cluster C1. Consequently, as illustrated in FIG. 12A, in addition to the score (score) according to the accuracy of entity linking, the final score (score_img) is associated with each of the entity candidates 11, 21, 31, and 41.

After the identification unit 125 identifies the largest degree of similarity and associates the final score with the entity candidate, the determination unit 126 determines a final entity from among the entity candidates based on the identified largest degree of similarity (step S7). For example, as illustrated in FIG. 12B, the determination unit 126 gives a predetermined weight to each of the score according to the accuracy of entity linking and the final score. In the present embodiment, the determination unit 126 gives a weight “0.5” (50%) to the score according to the accuracy of entity linking. The determination unit 126 gives a weight “0.5” (50%) to the final score.

After giving the weights, the determination unit 126 determines one of the entity candidates as the final entity, based on a total value (total_score) of the score described above and the final score described above to which the respective weights are given. For example, the determination unit 126 determines one of the entity candidates as the final entity, based on a linear combination of the score described above and the final score described above to which the respective weights are given. For example, in a case of the entity candidate 11, the determination unit 126 calculates a total value “0.74”. Likewise, in a case of the entity candidate 21, the determination unit 126 calculates a total value “0.49”. In a case of the entity candidate 31, the determination unit 126 calculates a total value “0.88”. In a case of the entity candidate 41, the determination unit 126 calculates a total value “0.43”. After calculating the total values, the determination unit 126 determines, for each word, the entity candidate of which the calculated total value is largest as the final entity.

In a case of the present embodiment, as illustrated in FIG. 12B, the determination unit 126 calculates the total value “0.88” for the entity candidate 31 and calculates the total value “0.43” for the entity candidate 41. Thus, for the word “radio tower”, the determination unit 126 determines the entity candidate 31 as the final entity. Likewise, the determination unit 126 calculates the total value “0.74” for the entity candidate 11 and calculates the total value “0.49” for the entity candidate 21. Thus, for the word “Minato-ku”, the determination unit 126 determines the entity candidate 11 as the final entity.

After determining the entities, the determination unit 126 displays a final result on the display device 720 (step S8) and ends the process.

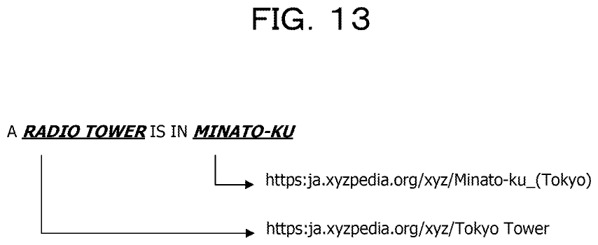

Consequently, as illustrated in FIG. 13, appropriate entities are displayed on the display device 720 in association with the respective words “radio tower” and “Minato-ku” included in the input text. As described above, according to the present embodiment, not predetermined images limited to a specific field such as Instagram (registered trademark) or movie review sites but images that may collected through a search of the communication network NW such as the Internet are used as related images. For example, related images independent of the predetermined images are collected from the image DB 111 and used. Because it is easy to collect such related images, there is an advantage that the versatility of entity linking is improved as compared with a case where a neural network specialized for a specific field is designed. According to the present embodiment, since images are used to improve the accuracy of entity linking, the accuracy of entity linking may be improved without depending on a specific language such as Japanese or English.

Although the preferred embodiment of the present disclosure has been described in detail above, the present disclosure is not limited to the specific embodiment according to the present disclosure, and various modifications and changes may be made within a scope of the gist of the present disclosure described in the claims. For example, the image clusters are generated in the embodiment described above. However, in addition to the image clusters, related word clusters may be generated, and may be used to improve the accuracy of entity linking.

The weight “0.5” is adopted in the present embodiment. However, the same weight may be changed to different weights in accordance with the design, operation, setting, or the like. For example, the determination unit 126 may give a weight “0.7” (70%) to the score according to the accuracy of entity linking and give a weight “0.3” (30%) to the final score, or these weights may be reversed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
extracting a plurality of candidates for an entity in a knowledge graph based on a word in text;
collecting related images related to the extracted candidates;
generating image clusters of the collected related images for the respective candidates;
calculating degrees of similarity between the generated image clusters; and
determining, as the entity, a candidate of which the image cluster indicates a higher degree of similarity among the candidates.

2. The non-transitory computer-readable recording medium according to claim 1, the process further comprising:
recursively collecting an image related to each of the related images based on a related word related to each of the collected related images.

3. The non-transitory computer-readable recording medium according to claim 1, the process further comprising:
collecting, from a database, the related images independent of a predetermined image associated with the text.

4. The non-transitory computer-readable recording medium according to claim 1, the process further comprising:
giving a score to each of the extracted candidates;
identifying a specific degree of similarity that is larger than any other degrees of similarity among the calculated degrees of similarity, and
determining, as the entity, a candidate of which the image cluster indicates a higher degree of similarity, based on the score and the specific degree of similarity.

5. The non-transitory computer-readable recording medium according to claim 4, the process further comprising:
giving a first weight to the specific degree of similarity and a second weight to the score; and
determining, as the entity, the candidate of which the image cluster indicates a higher degree of similarity, based on a total value of the score to which the second weight is given and the specific degree of similarity to which the first weight is given.

6. A control method, comprising:
extracting, by a computer, a plurality of candidates for an entity in a knowledge graph based on a word in text;
collecting related images related to the extracted candidates;
generating image clusters of the collected related images for the respective candidates;
calculating degrees of similarity between the generated image clusters; and
determining, as the entity, a candidate of which the image cluster indicates a higher degree of similarity among the candidates.

7. An information processing apparatus, comprising:
a memory; and
a processor coupled to the memory and the processor configured to:
extract a plurality of candidates for an entity in a knowledge graph based on a word in text;
collect related images related to the extracted candidates;
generate image clusters of the collected related images for the respective candidates;
calculate degrees of similarity between the generated image clusters; and
determine, as the entity, a candidate of which the image cluster indicates a higher degree of similarity among the candidates.
